(19) United States
(12) Patent Application Publication
(10) Pub. No.: US 2007/0143379 A1
(43) Pub. Date: Jun. 21, 2007

(54) Metadata driven deployment of applications

(75) Inventors: Ricard Roma i Dalfo, Redmond, WA (US); Sushil Kumar, Gachibowli (IN); Ramakrishnan Nagasamy, Gachibowli (IN); Manish Soni, Gachibowli (IN)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/365,270

(22) Filed: Mar. 1, 2006

Related U.S. Application Data
(60) Provisional application No. 60/748,921, filed on Dec. 9, 2005.

(51) Int. Cl. G06F 17/30

(52) U.S. Cl. 707/205

(57) ABSTRACT

A computing device includes a deployment engine to communicate with a deployment repository that includes metadata that is used in the deployment of an application. The metadata may include references or links to resources to be included in the deployment of the application. The deployment engine determines whether the deployment repository contains new or updated metadata and/or resources that the computing device can download. The metadata includes information that allows the deployment engine to correctly deploy or update an application on the computing device.

### RELATED APPLICATION(S)

This utility patent application claims the benefit under 35 United States Code § 119(e) of U.S. Provisional Patent Application No. 60/748,921 filed on Dec. 9, 2005, which is hereby incorporated by reference in its entirety.

### BACKGROUND

Many organizations are required to install applications to a large number of computing devices. In order to assist with this endeavor, automated tools have been developed to deploy the new software into an organization. Some of these automated tools allow organizations to obtain inventory information that may be used for planning and allow the administrators to schedule and control installation of the applications. These tools may also be used to schedule the deployment at particular times of the day in order to help alleviate the impact to users. Other tools might also be required to customize the installation depending on the application requirements.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computing device includes a deployment engine that communicates with a deployment repository that includes metadata which may specify references and/or links to resources (e.g., dynamic linked libraries, files, assemblies, etc.) that are to be included in the deployment of an application. These resources are typically located on a server that is accessible to the computing device. The deployment engine determines whether the deployment repository contains new or updated metadata and/or updated resources that the deployment engine on the computing device can download. The metadata includes information that allows the deployment engine to correctly install or update an application on the computing device. For example, the metadata can include information that allows the deployment engine to correctly install and/or configure the application and its required resources.

### BRIEF DESCRIPTION OF THE DRAWINGS

FIG. 1 is a block diagram representing an exemplary system that supports metadata driven application deployment;

FIG. 2 is a flow diagram representing an exemplary operational flow in deploying an application; and

FIG. 3 is a block diagram illustrating a computing environment that may be used according to exemplary embodiments.

### DETAILED DESCRIPTION

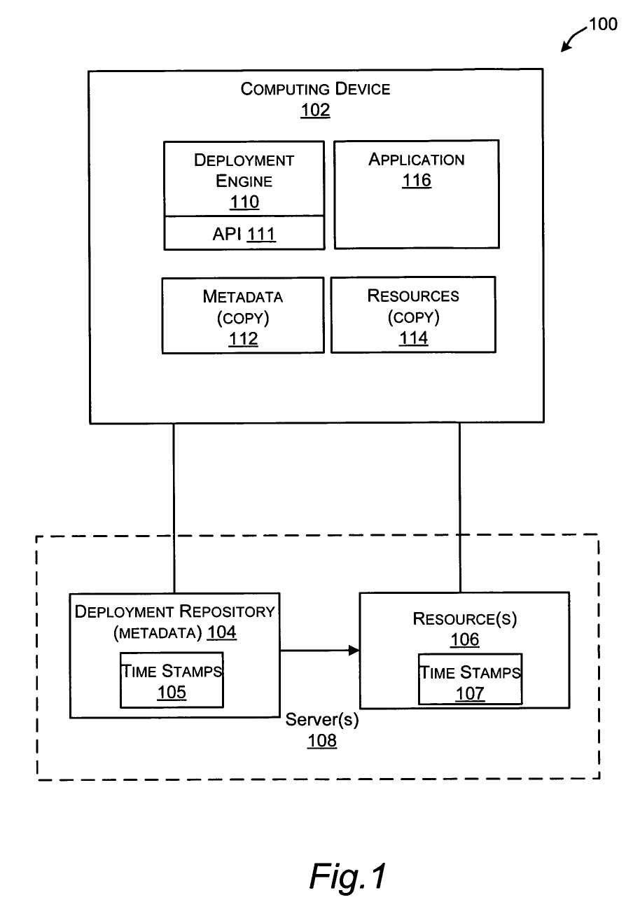

Referring now to the drawings, in which like numerals represent like elements, various embodiments will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

FIG. 1 illustrates an exemplary system 100 that supports metadata driven deployment of application(s), according to an embodiment. As illustrated, system 100 includes a computing device 102 (i.e., any device that can store and execute a software application), a deployment repository 104 that includes metadata and resources 106. In this embodiment, the deployment repository 104 and the resources 106 are accessible to the computing device 102 via one or more servers 108. The computing device 102 includes a deployment engine 110, application 116, metadata (copy) 112, and resources (copy) 114. Although not shown in FIG. 1, the system 100 may include additional computing devices similar to the computing device 102.

The deployment repository 104 includes metadata information that allows the deployment engine 110 to correctly deploy or update an application (e.g. application 116 on the computing device 102). For example, the metadata can include information that allows the engine 110 to correctly install and/or configure the application 116 in computing device 102. The deployment repository 104 may include information for multiple applications for all of the computing devices of the system 100 and, in addition, information used in determining what application(s) are to be installed/updated on each of the computing devices. Further, in one embodiment, the metadata corresponding to each application or application update is time stamped to indicate the most recent time the metadata was modified (or created). This time stamp information may be stored in time stamps 105.

The deployment engine 110 of the computing device 102 accesses or queries the deployment repository 104 periodically to determine if there are new application(s) or application update(s) to be installed on the computing device 102. In one embodiment, the deployment engine 110 periodically polls the deployment repository 104 for metadata corresponding to new or updated application(s) for the computing device 102. For example, in one embodiment, the engine 110 can query the deployment repository 104 for the timestamp(s) of metadata corresponding to application(s) (e.g. application 116) currently residing on the computing device 102. The deployment engine 110 can then compare the timestamp(s) to timestamp(s) of the most recently downloaded metadata corresponding to the application(s) and if they are not the same (i.e., the timestamp(s) of the metadata in the deployment repository 104 are more recent), then the deployment engine 110 can then download the “newer” metadata. In the case in which the metadata corresponds to a new application(s) that are deployed, rather than an update to an application already installed on the computing device 102, the deployment engine 110 may download the metadata corresponding to the new application(s) without performing a comparison of timestamps. The metadata downloaded to computing device 102 is indicated as metadata 112 in FIG. 1. Still further, in some embodiments, versioning of applications, resources and/or metadata can be used instead of “last modified” timestamps.

In operation, when an application is to be updated (or have resources updated), an authorized user, such as a system administrator, updates the metadata on the deployment repository 104 rather than directly updating the application (or resource) on the computing device 102. Similarly, when a new application and/or resource is to be installed on the computing device 102, an administrator can load metadata for installing the new application on the deployment repository 104 rather than directly on the computing device 102. This feature can be advantageous when the system 100 includes multiple computing devices with the same application and/or resource to be updated or initially installed. This feature provides a simple process (i.e., the updating of just the deployment repository 104) to deploy an application or update on multiple computing devices.

In one embodiment, the deployment engine 110 downloads the metadata on a transacted basis. For example, the deployment engine 110 can download the metadata conforming to ISO/IEC 10026-1:1992 Section 4, which describes the ACID (Atomicity, Consistency, Isolation, and Durability) attributes that are to be preserved in transacted information transfers. Consequently, downloads can be interrupted without losing or corrupting the metadata and/or resources currently residing on the computing device.

In this embodiment, the deployment engine 110 then processes the metadata to determine whether there are additional resources needed to correctly install the application(s). Resources can include dynamic linked libraries, files, assemblies, etc. In some embodiments, the metadata includes location information (e.g., URLs) of resources. The deployment engine 110 can then download the resource(s) using this location information. For example, in system 100, the deployment engine 110 would obtain the resource location information from the metadata 112 and, using this location information, download the resource(s) from the resources 106 on server(s) 108. The resource(s) downloaded to computing device 102 are indicated as resources 114. In some embodiments, the resources may also have time stamp or version information (107) that can be inspected before downloading the resource(s) so that only new or updated resource(s) are downloaded.

The deployment engine 110 can then correctly install the application(s) using the metadata 112 and resources 114 that has been downloaded to computing device 102. In some embodiments, the metadata 112 includes information needed by an installer application or wizard or other suitable program (not shown) to install the application(s), indicated as application(s) 116 in the computing device 102. In some embodiments, once the metadata 112 and the resources 114) are downloaded, one or more preselected events (e.g., a reboot, a launching or re-launching of the application, etc.) causes the deployment engine 110 to install the application(s).

In one embodiment, the deployment engine 110 stores the newly downloaded metadata 112 and/or resources(s) 114 in a temporary persistent directory (i.e., cached) until an event (described above) occurs to install the application(s) 116. In response to the event, the deployment engine 110 “remaps” the settings of the application and/or resources to the new/updated application and/or resources. Some embodiments allow a user to use an application currently residing on the computing device while an updated version is being downloaded. The above embodiments provide mechanisms to deploy or update application(s) 116 on the computing device 102 that are transparent to the user, automatic, and easy to administer.

In some embodiments, in downloading resource(s) 114, the deployment engine 110 preserves the pathname of the resource except for the root. For example, in one embodiment the deployment engine 110 changes the original root from the server 108 to the user's domain on the computing device 102. This feature simplifies the installation of the application(s) 116 and the reference(s) to the resource(s) 114.

In addition, in some embodiments, in storing the resource(s) 114, the deployment engine 110 provides an indication that the resource(s) 114 were downloaded from a network share. For example, in one implementation, the deployment engine 110 causes a property of each of the resource(s) 114 to indicate it is from a network zone (as opposed to local, which are generally assumed to be trusted by applications). In this way, the resource appears to be “non-local” to the application and appropriate security measures can be taken by the application(s) 116.

In some embodiments, the system 110 implements security features when storing the metadata 112 and the resource(s) 114 on the computing device 102. For example, the deployment repository 104 may require roles (or username) with passwords before allowing the computing device 102 to access the metadata of the deployment repository 104. In addition, the deployment engine 110 may associate access control lists (ACLs) with downloaded resource(s) 114 to ensure that only applications with permission can access the resource(s) 114.

In some embodiments, the deployment engine 110 provides a mechanism that allows any application to obtain a resource without having to have the location information for the desired resource. For example, in one embodiment, the deployment engine 100 exposes an API (application programming interface) 111 that applications can use to try to obtain a resource. An application would use the API to make calls on the deployment engine 110 with a name or identifier of the resource. The deployment engine 110 then checks the downloaded resources (e.g., resource(s) 114) for the requested resource and if not present, obtains the location (e.g., a URL) of the resource from the deployment repository 104. The deployment engine 110 then returns location information (either local or remote) to the application that made the call.

In some embodiments, the metadata 112 can include a time at which the deployment of the metadata and/or resources is to occur. This feature can be used by an administrator of the system 100 to synchronize the deployment of the application and/or resources over multiple computing devices in the system 100. For example, in one implementation, the computing devices of system 100 download and cache the metadata and/or resources for deployment of a particular application before a specified time (the time specified for the synchronized deployment). Then when that specified time is reached, all of the computing devices that downloaded the metadata and/or resources can substantially simultaneously perform the deployment.

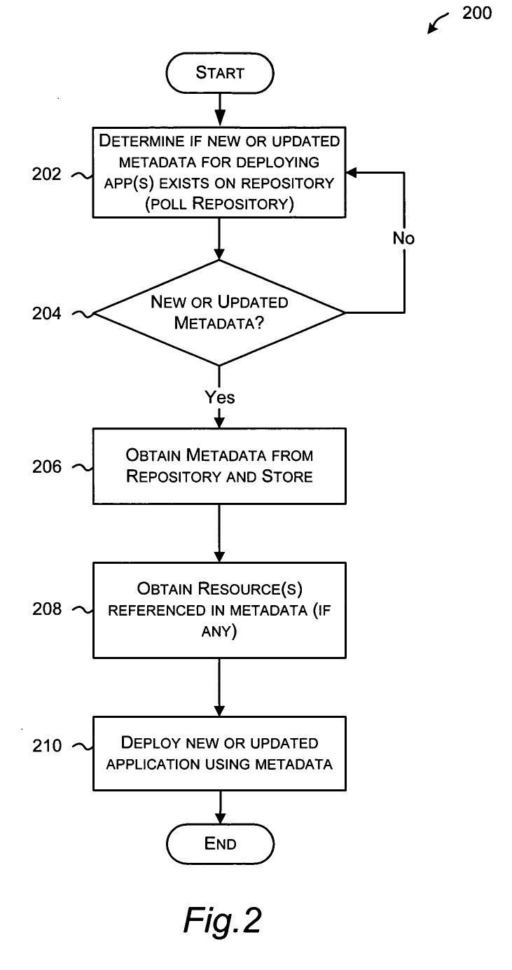

Referring now to FIG. 2, an illustrative process for deploying one or more applications using metadata will be described. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system. Accordingly, the logical operations illustrated and making up the embodiments of the described herein are referred to variously as operations, structural devices, acts or modules. These operations, structural devices, acts and modules may be implemented in software, in firmware, in special purpose digital logic, and any combination thereof.

After a start operation, operational flow 200 flows to operation 202 where it is determined whether one or more new or updated applications and/or resources are to be installed on a computing device. In one embodiment, the computing device includes a deployment engine such as, for example, the engine 110 (FIG. 1) that is configured to determine whether a new application or update is to be installed on the computing device. For example, in one embodiment the deployment engine periodically polls a deployment repository (e.g., a repository such as the deployment repository 104 of FIG. 1) for metadata that is newer or more recent than corresponding metadata already residing on the computing device. As in the aforementioned deployment repository 104, the deployment repository stores metadata that can be used by the deployment engine to install or update applications (or resources used by applications). When an application is to be updated (or have resources updated), an administrator updates the metadata on the deployment repository rather than directly updating the application (or resource) on the computing device. Similarly, when a new application and/or resource is to be installed on the computing device, an administrator can load metadata for installing the new application on the deployment repository rather than directly on the computing device. In this embodiment, the metadata stored by the deployment repository includes information (e.g., a timestamp or version indication) that allows the deployment engine to determine whether the metadata on the deployment repository is newer or more recent than corresponding metadata already residing on the computing device.

Flowing to decision operation 204, it is determined whether the metadata on the deployment repository is new or has been recently updated. According to one embodiment, a determination is made as to whether the metadata residing in the deployment repository is more recent than the corresponding metadata residing on the computing device.

If the metadata on the deployment repository is not new or updated, then the operational flow 200 returns to operation 202. However, if the metadata is new or updated, then the operational flow 200 proceeds to operation 206.

At operation 206, the computing device obtains the newer metadata from the deployment repository and stores the metadata on the computing device. In one embodiment, the aforementioned deployment engine downloads the metadata to the computing device from the deployment repository. In some embodiments, the metadata is downloaded on a transacted basis. As was described for system 100 (FIG. 1), the metadata can be stored in a temporary persistent directory (i.e., cached). Some embodiments allow a user to use an application currently residing on the computing device while an updated version is being downloaded.

Moving to operation 208, the computing device obtains one or more resources referenced (if any) in the metadata obtained at operation 206. In one embodiment, the aforementioned deployment engine downloads the referenced resources from location information (e.g., URLs) included in the metadata. In some embodiments, the resources may also have associated timestamp or version information that can be inspected before downloading the resource(s) so that only new or updated resource(s) are downloaded. In some embodiments, in downloading the resource, the pathname of the resource is preserved except for the root. For example, in one embodiment the original root of the resource's pathname is changed to the user's domain on the computing device.

In addition, in some embodiments, in storing the resource an indication is provided that the resource was downloaded from a network share. For example, in one implementation, a property of the resource is set to indicate it is from a network zone (as opposed to local, which are generally assumed to be trusted by applications). In this way, the resource appears to be “non-local” to the application and appropriate security measures can be taken by the application.

Moving to operation 210, the obtained metadata is used to install or update the application. In one embodiment, the aforementioned deployment engine uses the metadata to install the new or updated application. For example, in one embodiment when an event (e.g., a reboot, a launching or re-launching of the application, a specified time being reached, etc.) occurs, the deployment engine then installs the application using the metadata. The event can be specified in the metadata in some embodiments. In response to the event, the deployment engine “remaps” the settings of the application and/or resources to the new/updated application and/or resources.

Although operational flow 200 is illustrated and described sequentially in a particular order, in other embodiments, the operations described in the operations may be performed in different orders, multiple times, and/or in parallel. Further, in some embodiments, one or more operations described in the operation may be separated into another operation, omitted or combined. Further, the operation 202, 204, 206 and 208 of the operational flow 200 can be performed for updating a particular application even when the computing device is concurrently running an older version of that application.

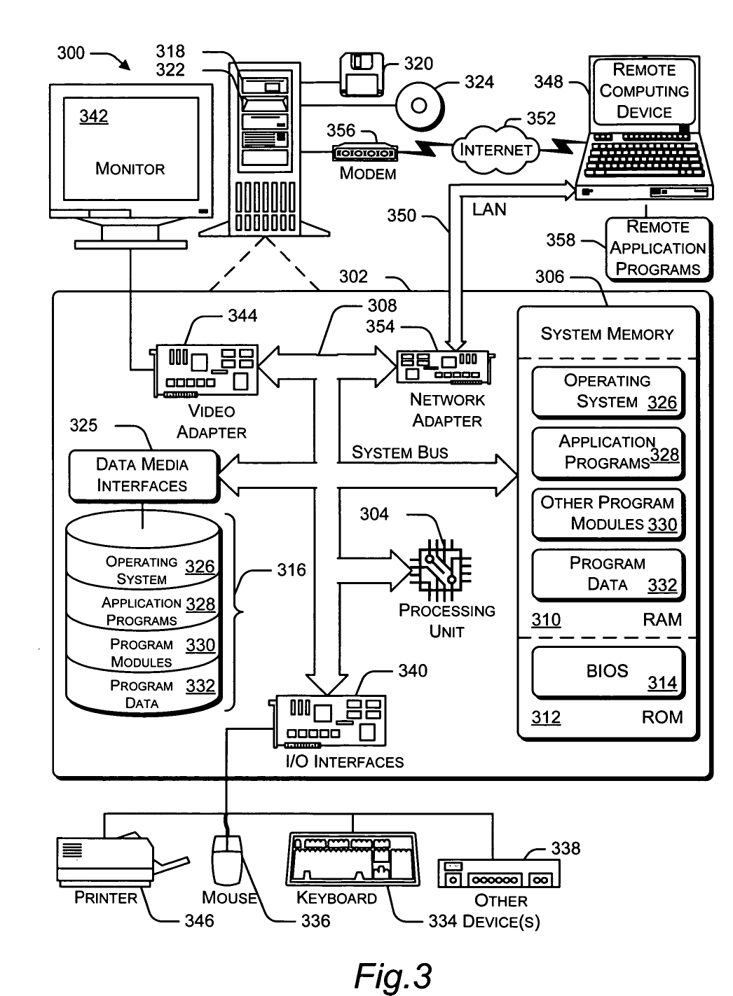

FIG. 3 illustrates a general computer environment 300, which can be used to implement the techniques described herein. The computer environment 300 is only one example of a computing environment and is not intended to suggest any limitation as to the scope of use or functionality of the computer and network architectures. Neither should the computer environment 300 be interpreted as having any dependency or requirement relating to any one or combination of components illustrated in the example computer environment 300.

Computer environment 300 includes a general-purpose computing device in the form of a computer 302. The components of computer 302 can include, but are not limited to, one or more processors or processing units 304, system memory 306, and system bus 308 that couples various system components including processor 304 to system memory 306.

System bus 308 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, a Peripheral Component Interconnects (PCI) bus also known as a Mezzanine bus, a PCI Express bus, a Universal Serial Bus (USB), a Secure Digital (SD) bus, or an IEEE 1394, i.e., FireWire, bus.

Computer 302 may include a variety of computer readable media. Such media can be any available media that is accessible by computer 302 and includes both volatile and non-volatile media, removable and non-removable media.

System memory 306 includes computer readable media in the form of volatile memory, such as random access memory (RAM) 310; and/or non-volatile memory, such as read only memory (ROM) 312 or flash RAM. Basic input/output system (BIOS) 314, containing the basic routines that help to transfer information between elements within computer 302, such as during start-up, is stored in ROM 312 or flash RAM. RAM 310 typically contains data and/or program modules that are immediately accessible to and/or presently operated on by processing unit 304.

Computer 302 may also include other removable/non-removable, volatile/non-volatile computer storage media. By way of example, FIG. 3 illustrates hard disk drive 316 for reading from and writing to a non-removable, non-volatile magnetic media (not shown), magnetic disk drive 318 for reading from and writing to removable, non-volatile magnetic disk 320 (e.g., a “floppy disk”), and optical disk drive 322 for reading from and/or writing to a removable, non-volatile optical disk 324 such as a CD-ROM, DVD-ROM, or other optical media. Hard disk drive 316, magnetic disk drive 318, and optical disk drive 322 are each connected to system bus 308 by one or more data media interfaces 325. Alternatively, hard disk drive 316, magnetic disk drive 318, and optical disk drive 322 can be connected to the system bus 308 by one or more interfaces (not shown).

The disk drives and their associated computer-readable media provide non-volatile storage of computer readable instructions, data structures, program modules, and other data for computer 302. Although the example illustrates a hard disk 316, removable magnetic disk 320, and removable optical disk 324, it is appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the example computing system and environment.

Any number of program modules can be stored on hard disk 316, magnetic disk 320, optical disk 324, ROM 312, and/or RAM 310, including by way of example, operating system 326 (which in some embodiments include low and high priority I/O file systems and indexing systems described above), one or more application programs 328, other program modules 330, and program data 332. Each of such operating system 326, one or more application programs 328, other program modules 330, and program data 332 (or some combination thereof) may implement all or part of the resident components that support the distributed file system.

A user can enter commands and information into computer 302 via input devices such as keyboard 334 and a pointing device 336 (e.g., a “mouse”). Other input devices 338 (not shown specifically) may include a microphone, joystick, game pad, satellite dish, serial port, scanner, and/or the like. These and other input devices are connected to processing unit 304 via input/output interfaces 340 that are coupled to system bus 308, but may be connected by other interface and bus structures, such as a parallel port, game port, or a universal serial bus (USB).

Monitor 342 or other type of display device can also be connected to the system bus 308 via an interface, such as video adapter 344. In addition to monitor 342, other output peripheral devices can include components such as speakers (not shown) and printer 346 which can be connected to computer 302 via I/O interfaces 340.

Computer 302 can operate in a networked environment using logical connections to one or more remote computers, such as remote computing device 348. By way of example, remote computing device 348 can be a PC, portable computer, a server, a router, a network computer, a peer device or other common network node, and the like. Remote computing device 348 is illustrated as a portable computer that can include many or all of the elements and features described herein relative to computer 302.

Logical connections between computer 302 and remote computer 348 are depicted as a local area network (LAN) 350 and a general wide area network (WAN) 352. Such networking environments are commonplace in offices, enterprise-wide computer networks, intranets, and the Internet.

When implemented in a LAN networking environment, computer 302 is connected to local network 350 via network interface or adapter 354. When implemented in a WAN networking environment, computer 302 typically includes modem 356 or other means for establishing communications over wide network 352. Modem 356, which can be internal or external to computer 302, can be connected to system bus 308 via I/O interfaces 340 or other appropriate mechanisms. It is to be appreciated that the illustrated network connections are examples and that other means of establishing at least one communication link between computers 302 and 348 can be employed.

In a networked environment, such as that illustrated with computing environment 300, program modules depicted relative to computer 302, or portions thereof, may be stored in a remote memory storage device. By way of example, remote application programs 358 reside on a memory device of remote computer 348. For purposes of illustration, applications or programs and other executable program components such as the operating system are illustrated herein as discrete blocks, although it is recognized that such programs and components reside at various times in different storage components of computing device 302, and are executed by at least one data processor of the computer.

Various modules and techniques may be described herein in the general context of computer-executable instructions, such as program modules, executed by one or more computers or other devices. Generally, program modules include routines, programs, objects, components, data structures, etc. for performing particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. As a non-limiting example only, communication media includes wired media such as a wired network or direct-wired connection, and wireless media such as acoustic, RF, infrared, and other wireless media. Combinations of any of the above are also included within the scope of computer readable media.

Reference has been made throughout this specification to “one embodiment,” “an embodiment,” or “an example embodiment” meaning that a particular described feature, structure, or characteristic is included in at least one embodiment. Thus, usage of such phrases may refer to more than just one embodiment. Furthermore, the described features, structures, or characteristics may be combined in any suitable manner in one or more embodiments.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for deploying an application on a first computing device, comprising:
obtaining metadata from a deployment repository that is located on a second computing device; wherein the metadata includes information that is used in deploying the application; and
deploying the application on the first computing device using the obtained metadata.

2. The method of claim 1, further comprising obtaining a resource in response to examining the obtained metadata.

3. The method of claim 2, further comprising treating the resource as a non-local resource during the deployment of the application on the first computing device.

4. The method of claim 2, further comprising periodically polling the deployment repository on the second computing device.

5. The method of claim 1, further comprising determining when the metadata that relates to the application has changed on the second computing device.

6. The method of claim 5, further comprising storing the metadata in a temporary persistent directory until an event occurs that indicates to deploy the application on the first computing device.

7. The method of claim 5, wherein determining when the metadata that relates to the application has changed on the second computing device comprises obtaining a first indicator from the first computing device and a second indicator from the second computing device and comparing the first indicator to the second indicator to determine when the metadata has changed; wherein the first indicator and the second indicator may be one of a time stamp and a version.

8. The method of claim 1, wherein obtaining the metadata from the deployment repository on the second computing device comprises downloading the metadata to the first computing device on a transacted basis.

9. The method of claim 3, further comprising obtaining a pathname to the resource and changing only a root of the pathname from an original root to a domain of the first computing device.

10. An apparatus for deploying applications using metadata, comprising:
a network interface that is configured to connect to a network;
a processor and a computer-readable medium;
an operating environment stored on the computer-readable medium and executing on the processor; and
a deployment engine that is operating under the control of the operating environment and operative to perform actions, including:
obtaining metadata from a deployment repository that is located on the network; wherein the metadata includes information that is used in deploying an application;
storing the obtained metadata on the computer-readable medium;
obtaining a resource that relates to the obtained metadata; and
deploying the application using the obtained metadata.

11. The apparatus of claim 10, wherein obtaining the metadata from the deployment repository that is located on the network comprises determining when the metadata has been updated.

12. The apparatus of claim 11, wherein storing the obtained metadata on the computer-readable medium comprises storing the metadata in a temporary persistent directory until an event occurs that indicates to deploy the application.

13. The apparatus of claim 11, wherein determining when the metadata has been updated comprises comparing timestamp information or version information.

14. The apparatus of claim 13, wherein obtaining the metadata from the deployment repository on the network comprises downloading the metadata on a transacted basis.

15. The apparatus of claim 13 wherein the obtained metadata includes at least one access control.

16. The apparatus of claim 13, wherein the application is configured to query the deployment engine for a location of the resource.

17. A computer-readable medium having computer executable instructions for providing metadata for the deployment of applications, comprising:
accessing metadata from a deployment repository that is associated with deploying an application;
accessing a resource that is associated with the metadata; and
providing the metadata and the resource to computing devices;
wherein the metadata includes information that is used in deploying the application on the computing devices.

18. The computer-readable medium of claim 17, further comprising associating an indicator with the metadata that indicates the metadata has changed.

19. The computer-readable medium of claim 17, further comprising updating the metadata within the deployment repository when the application is to be updated on the computing devices.

20. The computer-readable medium of claim 17, further comprising installing metadata within the deployment repository when the application is to be installed on the computing devices.
